(19) United States
(12) Patent Application Publication
(10) Pub. No.: US 2026/0230823 A1
(43) Pub. Date: Aug. 6, 2026

(54) METHODS FOR WTRU MEMBER SELECTION ASSISTANCE BASED ON PER-APP USER CONSENT

(71) Applicant: InterDigital Patent Holdings, Inc., Wilmington, DE (US)

(72) Inventors: Achref Methenni, Montreal (CA); Saad Ahmad, Montreal (CA); Samir Ferdi, Kirkland (CA); Ulises Olvera-Hernandez, Saint-Lazare (CA)

(73) Assignee: InterDigital Patent Holdings, Inc., Wilmington, DE (US)

(21) Appl. No.: 19/157,491

(22) PCT Filed: Feb. 20, 2024
(86) PCT No.: PCT/US2024/016452

§ 371 Date: Aug. 18, 2025

Related U.S. Application Data
(60) Provisional application No. 63/447,012, filed on Feb. 20, 2023.

(51) Int. Cl. H04W 12/088; H04W 8/20; H04W 48/16

(52) U.S. Cl. CPC H04W 12/088; H04W 8/20; H04W 48/16

(57) ABSTRACT

Procedures and embodiments for WTRU member selection based on per-app user consent may be described herein. A network exposure function (NEF) may receive filtering criteria and/or a list of target WTRUs from an application function (AF). The filtering criteria may be based on user consent. The NEF may receive WTRU subscription data from the unified data management (UDM) comprising user consent value(s) associated with an application or multiple applications. The NEF may perform filtering for member selection assistance based on the user consent information and/or other filtering criteria. The NEF may send the filtered list of WTRUs to the AF.

### CROSS-REFERENCE TO RELATED APPLICATIONS

This application claims the benefit of U.S. Provisional Patent Application No. 63/447,012 filed on Feb. 20, 2023, the entire contents of which are incorporated herein by reference.

### BACKGROUND

Wireless transmit/receive unit (WTRU) member selection assistance for application operations may be performed. 5G system (5GS) assistance to Federated Learning (FL) member selection may be supported, and WTRU member selection assistance functionality may be specified. This functionality may be exposed by the 5G core (5GC), and it may be triggered upon receipt of a request from an Application Function (AF) comprising a list of candidate WTRUs and/or additional information.

The request from the AF for the list of candidate member WTRUs may include an initial list from which candidate WTRU members are to be selected, a time window that the AF may provide to indicate where it needs the candidate WTRU(s) to be selected to participate in the application operation, and/or one or more filtering criteria which may be used by the 5GC to derive the list of candidate member WTRU(s) that match the filtering criteria. Examples of filtering criteria may include the location of the WTRU(s) (e.g., to indicate that the candidate WTRU(s) should be in a certain location to be eligible to be selected as a member WTRU).

### SUMMARY

A network node may comprise a processor configured to receive, from an application function (AF), a list of wireless transmit/receive units (WTRUs) and/or one or more filtering criteria. The filtering criteria comprise a user consent criterion. The processor may be further configured to receive, from a unified data management (UDM), respective subscription data for each WTRU of the list of WTRUs. The subscription data may comprise a respective user consent value associated with the WTRU. The processor may be further configured to filter the list of WTRUs received from the AF based on the filtering criteria and the received user consent values. The processor may be further configured to send, to the AF, the filtered list of WTRUs.

The network node may be a network exposure function (NEF). Filtering the list of WTRUs may comprise determining for each WTRU of the list of WTRUs, whether the WTRU is an eligible candidate WTRU. The processor may be further configured to receive, from the AF, a time duration associated with the user consent criterion. The processor may be further configured to receive, from the UDM, a respective characteristic associated with the user consent values, wherein the respective characteristic indicates that the user consent value is associated with uniform consent or strict consent.

The filtering criteria may comprise a minimum number of WTRUs, a maximum number of WTRUs, a WTRU location, an area of interest, a QoS of a target WTRU, and/or a preferred access or radio access technology type. There may be a first user consent value associated with a first application or group of applications, and a second user consent value associated with a second application or group of applications. The respective user consent value may be associated with data collection for one or more applications running on the respective WTRU. The list of WTRUs received from the AF may be further filtered based on a security status criterion.

The processor may be further configured to send, to the UDM, a request for the respective subscription data for each WTRU of the list of WTRUs. The request may comprise an application identifier (ID), an application group ID, and/or an application category.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example procedure for WTRU member selection assistance based on user plane security.

FIG. 3 illustrates an example procedure for WTRU member selection assistance based on per-app user consent.

### DETAILED DESCRIPTION

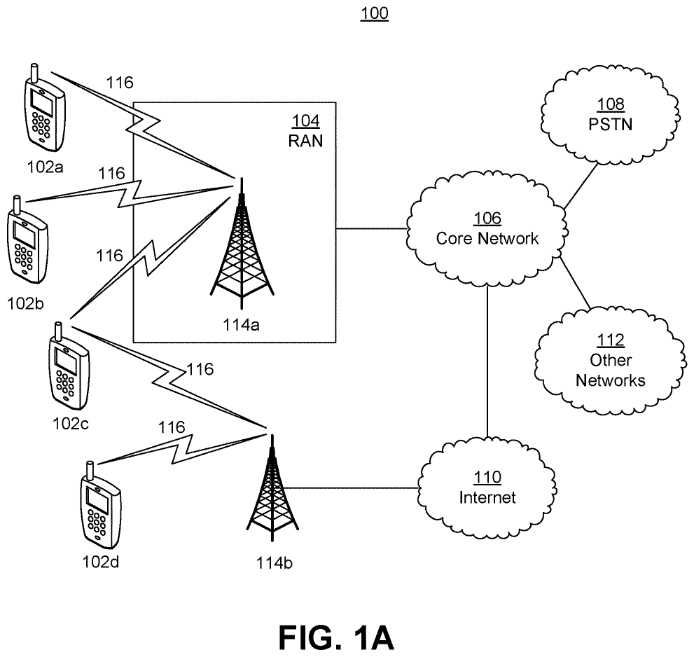

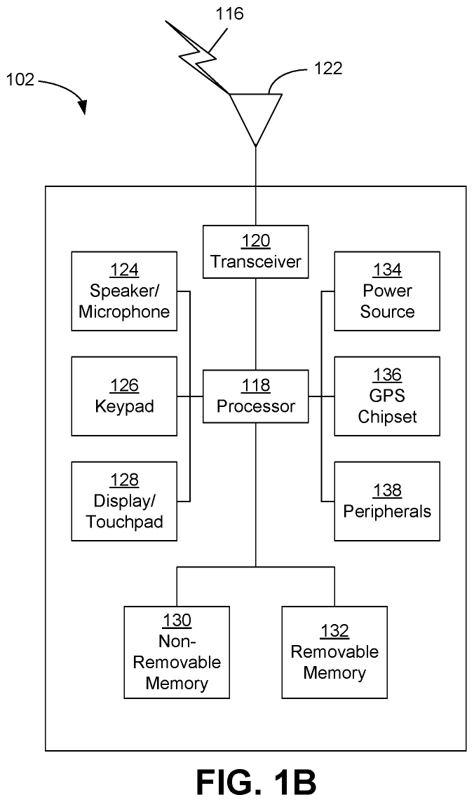

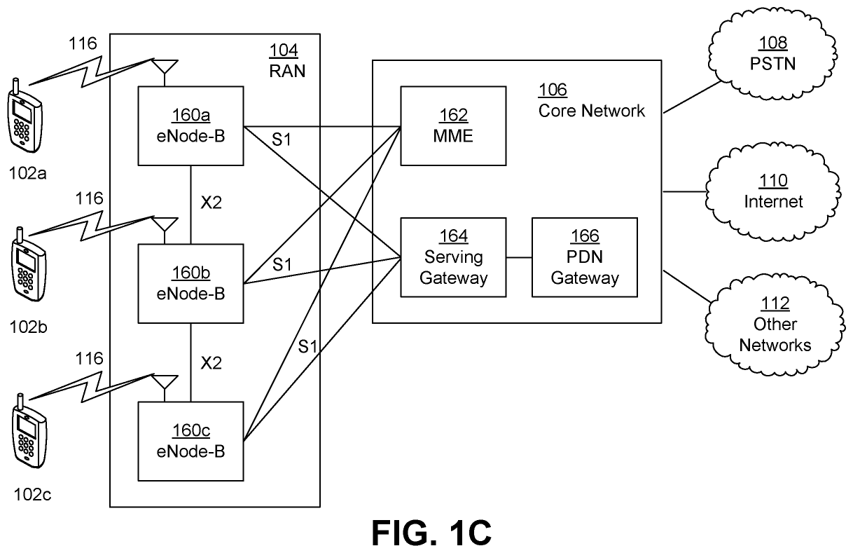

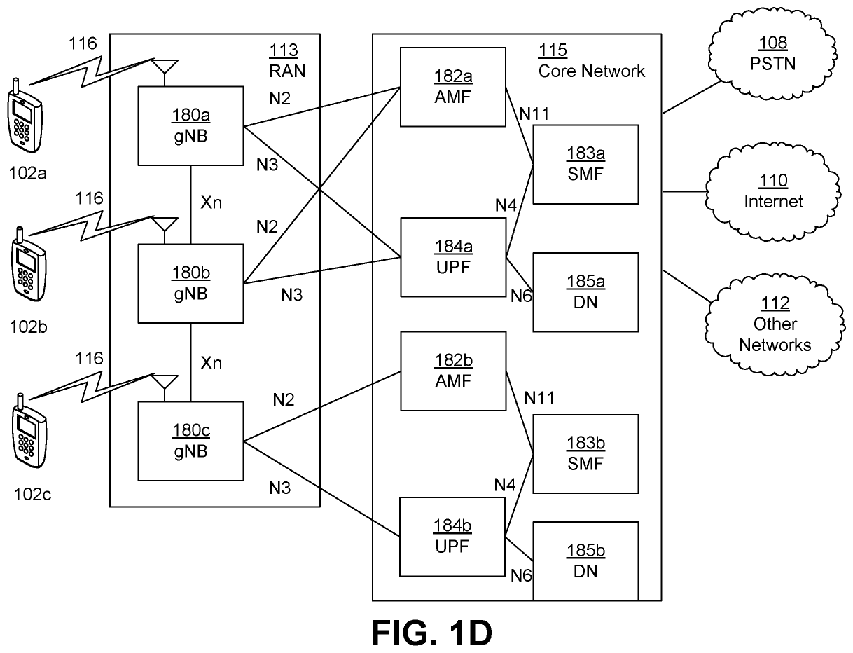

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication.

Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities for WTRU member selection assistance based on a user plane (UP) security status may be described herein. A network node (e.g., a network exposure function (NEF)) may receive filtering criteria and/or a list of wireless transmit/receive units (WTRUs) from an application function (AF). The filtering criteria may be based on the security status of a user plane session. The security status of the user plane session may comprise an integrity aspect and/or a confidentiality aspect. The network node may send a message to a session management function (SMF) based on the message received from the AF. The message may indicate for the SMF to check the security status of one or more (e.g., each) of the WTRUs in the list received from the AF. The network node (e.g., the NEF) may receive the security status of one or more (e.g., each) of the WTRUs from the SMF. The network node (e.g., the NEF) may perform filtering based on the received security status from the SMF (e.g., and/or one or more other filtering criteria). The network node (e.g., the NEF) may send the filtered list of WTRUs to the AF.

Systems, methods, and instrumentalities for WTRU member selection assistance based on user consent may be described herein. User consent may be per-application consent. A network node (e.g., the NEF) may receive filtering criteria and/or a list of WTRUs from the AF. The filtering criteria may comprise a user consent criterion. The network node (e.g., the NEF) may request subscription data (e.g., associated with an AF operation) from a unified data management (UDM). The network node (e.g., the NEF) may check whether the WTRU subscription data includes user consent if it does, or does not, receive a user consent filtering criterion from the AF. The network node (e.g., the NEF) may receive, from the UDM, respective subscription data for each WTRU of the list of WTRUs. The subscription data may comprise a respective user consent value associated with the WTRU. The network node (e.g., the NEF) may perform filtering based on user consent information (e.g., and/or one or more other filtering criteria). The network node (e.g., the NEF) may send the filtered list of WTRUs to the AF.

Security may be taken into consideration when executing WTRU member selection assistance. Security status(es) (e.g., of a user plane session) for member WTRU(s) may be included in an initial list of WTRUs provided by an AF. The AF may provide the list of WTRUs and/or security status(es) to the 5G core (5GC), which may trigger WTRU member selection assistance. In examples, WTRU member selection assistance may not be triggered if the 5GC (e.g., the NEF) derives the WTRU member(s).

Security considerations regarding a WTRU communication session may consider whether the UP traffic over the air is integrity protected and/or confidentiality protected. The UP security status may comprise an integrity aspect and/or a confidentiality aspect. Integrity protection may be desired, for example, to prevent tampering of transmitted data to mitigate potential interference against federated learning (FL) operations/sessions. Confidentiality may be desired to prevent leakage of information to mitigate privacy attacks.

User consent may be taken into consideration when executing WTRU member selection assistance. The filtering criteria provided by the AF to the 5GC for assistance with WTRU member selection may comprise, for example, WTRU trajectory and/or direction, and/or a QoS of a (e.g., each) target WTRU(s). In examples, the filtering criteria may solicit the network data analytics function (NWDAF) network function to derive analytics for the AF and/or to assist in determining the candidate WTRU(s) to participate in an artificial intelligence/machine learning (AIML) operation.

The NWDAF may check the user consent for the purpose of analytics or model training. For example, the NWDAF may check the user consent if the target of analytics reporting or target of ML model reporting is an Internal/External Group ID, a list of subscription permanent IDs (SUPIs), and/or “any WTRU”. User consent may be bound to the purpose of data collection. The purpose may have the value “analytics” to indicate that the consent is to use the data to produce analytics. It may also have the value “model training” which may indicate the user data is used by the NWDAF for ML model training purposes (e.g., and not for inference). In examples, user consent may not be sufficient to enable the user to choose between different applications or types of applications that the 5GC/NWDAF may use when generating analytics and providing result to AF (e.g., if the AF is a data collection AF).

User consent may be taken into consideration when the selection of WTRU member(s) goes beyond the original set of WTRU candidates provided by the AF. In examples, the AF provides a list, which may be restrictive. For example, there may be WTRUs in the area of interest (AoI) that comply with certain filtering criteria that may be selected as member WTRU candidates. These additional WTRUs may not be indicated by the AF. If there is a restrictive list, the 5G system (5GS) may be unable to select additional member WTRUs.

In examples, going beyond the initially requested list of WTRUs by the AF may provide advantages. For example, for FL, a WTRU may be willing to participate in the AIML assistance operation, and may be a candidate for an AIML application operation (e.g., the AIML application may indicate to the network that it wishes for the network to include potential candidate WTRUS that are not part of the initial list of requested WRTUs).

Filtering criteria may be restrictive. For example, filtering criteria used in WTRU member assistance functionality may not include information/criteria to allow for selection of candidate WTRUs beyond the initial list provided by the AF (e.g., volunteering WTRUs), and/or additional filtering criteria to enable the 5GC to select member WTRU candidates (e.g., from an area of interest (AoI) or a single network slice selection assistance information (S-NSSAI)/data network name (DNN) combination).

Enhancements to allow WTRU member selection assistance functionality to take a security status and/or more granular user consent information into consideration may be described herein. Embodiments described herein may be applicable to AIML application(s), general application(s), and/or applications that include an AF request to an NEF. For example, an AIML application may benefit from one or more embodiments described herein (e.g., for FL).

WTRU member selection assistance based on user plane security status may be performed. For example, an application function (AF) may send a request to assist with WTRU member selection, which may take user plane security status into consideration.

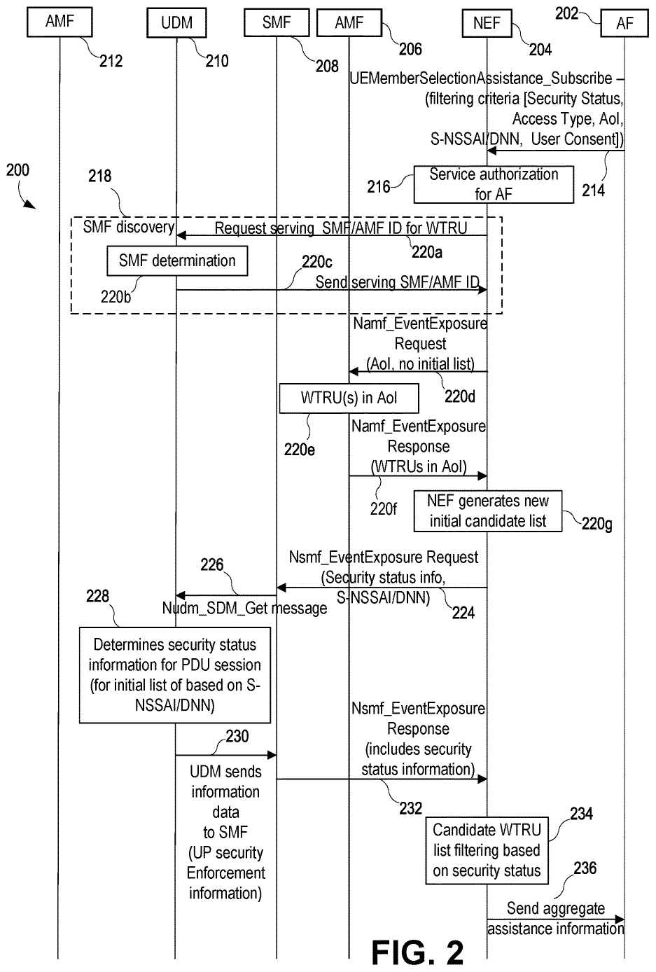

FIG. 2 illustrates an example procedure 200 for WTRU member selection assistance based on user plane security. The NEF 204 may receive filtering criteria and/or a list of WTRUs from the AF 202. The NEF 204 may be a network function that provides exposure of network related information (e.g., capabilities, events, analytics, etc.), and/or may provide WTRU member selection assistance to, for example, 3rd party/Application Functions. The filtering criteria may comprise security status information (e.g., a security status criterion). The security status information may comprise an integrity aspect and/or a confidentiality aspect (e.g., integrity, confidentiality, both, or neither) of the UP session. Based on the received security status criterion in the message from the AF 202, the NEF 204 may send a message to an SMF 208 requesting the security status of a (e.g., each) WTRU in the list received from the AF 202. The NEF 204 may receive the security status of the (e.g., each) WTRU from the SMF 208. The NEF 204 may perform filtering based on the security status(es) received from the SMF 208 (e.g., and/or one or more other filtering criteria). The NEF 204 may send the filtered list of WTRUs to the AF 202.

At 214, the AF 202 may send a request to a 5G system (5GS) network node (e.g., the NEF 204) to request assistance for WTRU member selection. The request may use an Nnef_UEMemberSelectionAssistance service. The request (e.g., message) may be a subscribe service operation. In examples, for a subscribe service operation, the AF 202 may subscribe to notification(s) from the 5GS about WTRU member selection, for example according to the provided filtering criteria. The request (e.g., message) may be in the form of a request service operation. In examples, for a request service operation, the AF 202 may ask the 5GS (e.g., via the NEF 204) to provide information. The information requested by AF 202 may be associated with a list of WTRUs and/or additional information based on the parameters provided in the request. The request (e.g., to the NEF 204) from the AF 202 may comprise a list of WTRUs, one or more time windows, and/or one or more filtering criteria. The filtering criteria may comprise a security status of a UP session.

In examples, the request from the AF 202 may comprise an initial list of WTRUs. The initial list of WTRUs may be target WTRUs for the purpose of member selection. The list of WTRUs may or may not be restrictive. For example, the list of WTRUs may be an initial list of WTRUs for the 5GS to choose from that may be added to. For example, if the AF 202 indicate that the list of WTRUs is nonrestrictive, the AF 202 may request for the 5GS to provide additional candidate WTRUs that fulfill the filtering criteria. In examples, the 5GS may identify additional WTRUs not provided on the initial list that fulfill the filtering criteria (e.g., to fulfill the minimum number of WTRUs).

The AF 202 may send no list of WTRUs (e.g., may fail to send a list of WTRUs), and/or may request the 5GS to conduct an autonomous selection. For autonomous selection, the AF 202 may indicate for the 5GS to generate a member WTRU list and/or to provide additional member WTRU candidates beyond those requested by the AF 202.

The request from the AF 202 may include one or more time windows. For example, the AF 202 may include time window(s) to indicate when the AF 202 expects/foresees the targeted WTRUs to be involved in an application operation. For example, the AF 202 may include time window(s) associated with FL training cycle(s).

The request from the AF 202 may comprise one or more filtering criteria. The filtering criteria may comprise one or more of: a number of WTRUs to be considered for the application operation (e.g., a minimum number or maximum number); a WTRU(s) location, which may indicate a location where the WTRUs to be selected for application operation should be; an area of interest (AoI), which may indicate a location preference and/or requirement for the WTRU(s) in order to be eligible for member selection; a target WTRU Quality of Service (QoS) (e.g., for each WTRU), which may indicate desired QoS parameters for target WTRU(s) to have in order to be eligible for the application operation; and/or a preferred access/Radio Access Technology (RAT) type. For example, the AF may indicate that it prefers for WTRUs to perform an action (e.g., an AIML operation, FL) using a specific access (e.g., Wi-Fi, 3gpp access, etc.).

The filtering criteria may comprise security status(es) associated with WTRUs. The security status of WTRU UP session(s) may be taken into consideration to assist with member selection for an application operation (e.g., alternatively or additionally to other filtering criteria). UP security status filtering criteria may be associated with the purpose of member selection. In examples, the AF 202 may be interested in knowing whether the session is integrity protected and/or confidentiality protected, both integrity and confidentiality protected, or neither. The security status information may comprise an integrity aspect and/or a confidentiality aspect, and may refer to these attributes of the session (e.g., PDU session, UP session).

The UP security status may include an integrity aspect associated with a PDU session. The integrity aspect may indicate whether the status of the integrity protection for the UP is required (e.g., UP integrity protection shall be applied for all the traffic on the considered PDU session); preferred (e.g., the user plane integrity protection should be applied to the traffic that is carried within the PDU session, yet it is a reason to reject the PDU session establishment or release the PDU session if the integrity protection can no longer be supported); or not needed (e.g., integrity protection shall not apply to the considered PDU session).

The UP security status may include a confidentiality aspect pertaining to the PDU session. There may be one or more (e.g., three) modes for the UP-confidentiality protection. Modes for the confidentiality aspect may be described similarly to modes for the integrity aspect. In examples, the modes may be required, preferred, and/or not needed. The confidentiality aspect may focus on the UP-confidentiality protection of (e.g., all) traffic on the considered PDU session.

Security status information (e.g., sent from the AF 202 at 214) may refer to the AF 202 asking the NEF 204 to perform filtering. The AF 202 may ask the NEF 204 to perform filtering based on if the respective UP session of a WTRU (e.g., each WTRU) in the list is confidentiality protected, integrity protected, both (e.g., confidentiality and integrity protected), or neither.

Prior to the AF 202 sending a request to the 5GS at 214 via the NEF 204, one or more WTRUs may or may not have an already-established PDU session with the 5GS where they can exchange data traffic. For example, one or more WTRUs may have established PDU sessions after the WTRU member selection assistance request was received at the 5GS, but before the required time window where analytics may be collected. The AF 202 may request a manner for the security status to be determined. For example, if no security status is defined in the unified data management (UDM), the AF 202 may request that the security status be determined based on the S-NSSAI.

The filtering criteria in the request from the AF 202 to the 5GS at 214 through the NEF 204 may comprise security status information. Aspects of UP security, such as confidentiality and/or integrity protection, may differ from one application to another. For example, aspects may differ based on needs, policies, and/or requirements of an application. This information may be provided by the application so that the 5GS takes it into consideration when assisting with WTRU member selection.

For example, for a given AIML application, integrity protection and confidentiality may be required. For other applications, confidentiality may be required, whereas integrity protection may be preferred. In this sense, the AF 202 may request the NEF 204 to include a security status value of the UP for the application operation (e.g., by linking the application ID to a security status value). This may include the mode for UP integrity protection (e.g., whether it is preferred, required or not needed) and/or the mode for UP confidentiality protection (whether it is preferred, required or not needed).

Alternatively or additionally, the filtering may be performed according to the security status of the PDU session (e.g., whether the UP session is integrity protected, confidentiality protected, both (e.g., integrity and confidentiality protected) or neither).

The UP-integrity protection may be related to the maximum supported data rate per WTRU for integrity protection for data radio bearers (DRBs). This information may be provided by the WTRU in, for example, the integrity protection maximum data rate Information Element (IE) during a PDU session establishment procedure. For example, the AF 202 may request the security status according to “integrity protection” be not used as filtering criteria when selecting member WTRUs, for example if the maximum supported data rates are below a (e.g., pre-defined or pre-configured) threshold. The UP integrity protection mode may be requested to account for maximum supported data rate per WTRU. This information may be very useful for the application function.

At 216, the NEF 204 may authorize the service request from the AF 202. In examples, the NEF 204 may authorize the service request from the AF 202 via service authorization mechanisms available in a 5G network.

The NEF 204 may perform an SMF discovery 218. The SMF discovery 218 may be performed for a (e.g., each) WTRU in the list of target WTRUs. In examples, the NEF 204 may be unable to retrieve UP security status information from the UDM 210 registry directly. If the NEF 204 is unable to retrieve UP security information from the UDM 210 registry directly, the NEF 204 may retrieve this information from the WTRU, serving SMF 208, and/or indicate for the SMF 208 to get this information from the UDM 210 on its behalf.

SMF discovery 218 may comprise the NEF 204 sending a request at 218a to the UDM 210 to inquire about the SMF ID of the SMF 208 serving the WTRU. The request from the NEF 204 may comprise a WTRU identifier, DNN/S-NSSAI information, and/or application related information (e.g., an application ID). At 220b, the UDM 210 may determine the SMF 208 serving the WTRU. The UDM 210 may determine the SMF 208 serving the WTRU based on parameters provided in the request from the NEF 204. At 220c, the UDM 210 may send the SMF ID to the NEF 204.

There may be a WTRU determination based on an area of interest. At 220d, the NEF 204 may request a WTRU ID from a WTRU in a specific area of interest. For example, there may be a WTRU determination based on an area of interest when the NEF 204 is not provided an initial list of target WTRUs and/or when the AF 202 indicates that additional candidates may be added from the AoI. At 220e, the AMF 206 may identify WTRUs within the AoI. At 220f, the AMF 206 may send a list of WTRUs to the NEF 204 based on the AoI. The NEF 204 may use the list of WTRUs in the AoI to generate a new list of candidate WTRUs at 220g.

At 224, the NEF 204 may send a message to the SMF 208 to request UP security status of the PDU session(s) in question. In examples, the message may be sent after the NEF 204 has determined the SMF serving the WTRU at 218, and may be based on the security status information received from the AF 202 at 214. The message may comprise an application ID and/or application detection information. The SMF 208 may identify the PDU session(s) that can carry the AIML traffic in question based on the application ID and/or application detection information. The message may comprise UP security status information comprising the UP-integrity protection mode aspect and/or the UP-confidentiality mode aspect.

The NEF 204 may subscribe to receive notifications/updates when certain events happen. In examples, the NEF 204 may subscribe to periodically receive the status of the UP of the PDU session, get notified when the PDU session is released, etc. The message may be sent using the Nsmf_EventExposure service. The NEF 204 may use the Nsmf_EventExposure service operation to subscribe.

The NEF 204 may use a (e.g., new) service operation to request UP security status information from the SMF 208. For example, the NEF 204 may request UP security status information via a Nsmf_EventExposure Request (e.g., instead of a subscribe). Using this service operation, the NEF 204 may request certain UP security related information from the SMF 208. The NEF 204 may utilize a service operation to avoid receiving notifications regarding this information.

If the SMF 208 has the UP security information stored locally, the SMF 208 may send it to the requesting NEF 204. If the S-NSSAI/DNN was provided to the SMF 208, the SMF 208 may select one or more (e.g., all) WTRU(s) using a PDU Session using a S-NSSAI/DNN that matches the requested S-NSSAI/DNN. The SMF 208 may not have the information locally stored, in which case it may solicit the UDM 210 to provide the information.

At 226, the serving SMF 208 may send a message/request to the UDM 210 to retrieve the UP security status information (e.g., which may be referred to as UP security enforcement information) for the user of the considered PDU session (e.g., if the SMF 208 does not have the information stored locally). This message may be optional based on the requested and/or available information. For example, the SMF may already have the information about the security status, and/or may have (e.g., all) information pertaining to the PDU session. In examples, the SMF 208 may invoke the Nudm_SDM_Get API for the request. The SMF 208 may include the PDU session IDs in the request.

At 228, the UDM 210 may authorize the request received from the SMF 208 and/or may determine the UP security status information for the WTRU for the considered PDU session IDs. At 230, the UDM 210 may provide the SMF 208 with the UP-security status information for the WTRU and PDU session in question. As with 226, this may be optional based on the requested and/or available information. For example, the SMF may already have the information about the security status, and/or may have (e.g., all) information pertaining to the PDU session.

At 232, the SMF 208 may send a message to the NEF 204 comprising the UP security status information. For example, the UP security status information sent from the SMF 208 may include a respective security status for each WTRU of the list of WTRUs received at 214. The SMF 208 may use the existing Nsmf_EventExposure Notify service operation or a new Nsmf_EventExposure Response service operation, depending on the NEF message. The NEF 208 may have received the information about the different WTRUs, the UP-security status of their PDU sessions, and/or other information depending on the parameters included in the WTRU member selection assistance request (e.g., at 214).

The NEF 204 may perform filtering of the list of WTRUs at 234. The NEF 204 may filter candidate WTRUs based on the security status (e.g., received from the SMF 208) and/or other filtering criteria to determine whether the candidate WTRUs are eligible candidate WTRUs. The NEF 204 may perform filtering by determining if a WTRU (e.g., each WTRU) in the list of WTRUs matches the filtering criteria provided by the AF 202 (e.g., at 214). In examples, the UP security status of a WTRU's PDU session (e.g., provided by the SMF at 232) may be used for filtering. For example, the filtering criteria provided by the AF 202 may comprise UP integrity protection mode as required and UP-confidentiality protection mode as preferred. For a first WTRU, the PDU session of interest may have a UP confidentiality protection mode of preferred and a UP integrity protection as preferred. The NEF 204 may identify that the first WTRU does not match the security status criteria provided by the AF 202, and may not be selected during the assistance operation.

The NEF 204 may determine and/or select the eligible WTRUs at 234, and may send the consolidated result (e.g., a filtered list) to the AF 202 at 236. The message from the NEF 204 may comprise information requested by the AF 202 at 214. For example, the message from the NEF 204 may include the security status of a WTRU (e.g., each WTRU) of the list of WTRUS.

WTRU member selection assistance based on per-application (app) user consent may be described herein. In examples, the WTRU member selection assistance function may be enhanced to include user consent in the filtering criteria.

In examples, filtering criteria for member assistance selection functionality may involve the network data analytics function (NWDAF), and may include WTRU trajectory and/or direction, etc. The NWDAF may collect data and/or process data to calculate and determine specific analytics and metrics. The NWDAF may provide a result to the AF.

User consent may be implicated based on collection of the user data by the NWDAF. User consent information may comprise a per-purpose consent, which may have one or more (e.g., two) values (e.g., training and/or analytics values). User consent values may be stored at the UDM. The consumer NF function (e.g., the NWDAF) may check with the UDM to request/retrieve the user consent information. For example, for a “training” user consent value, a user may consent to have their data collected and used to train AIML models that are used by the NWDAF. For example, for an “analytics” user consent value, the user may consent to have their data collected and used to infer and determine analytics by the NWDAF.

One or more of the embodiments herein may describe expanded granularity of user consent information. In examples, user consent information may comprise a per-app label. The per-app label may indicate that the user consents to have their data collected, used for inference, and/or used to calculate some analytics in order to provide metrics to entities (e.g., application functions) on the level of a given app or group of apps. In examples, a user may consent to provide this service to particular applications (e.g., specific applications, a group of applications, and/or a category of applications). In examples, a user may give consent for their data to be collected and/or used for some applications with additional criteria (e.g., for a certain period of time, for a certain location, etc.). For example, the user may provide consent to have their data collected and used for training and/or analytics if the application belongs to a “Federated Learning” category or group, but may not provide consent to collect and use their data for training and/or analytics for applications that have the category “commercial surveillance”.

WTRUs may be categorized based on user consent. For example, user consent categories may include differentiated (e.g., strict) consent and/or uniform consent. For differentiated consent, users of WTRUs may provide their consent on a per-app basis, and may differentiate between different applications (e.g., categories of application, group of applications, etc.) when providing their consent. For uniform consent, users of WTRUs may provide their consent for one or more (e.g., all) applications, and may not differentiate between applications when providing consent.

Procedures and embodiments for WTRU member selection based on user consent may be described herein. An application function may provide parameters regarding the user consent of the target WTRUs for member selection assistance. A NEF may retrieve user consent information and may use per-app user consent to assist in WTRU member selection assistance.

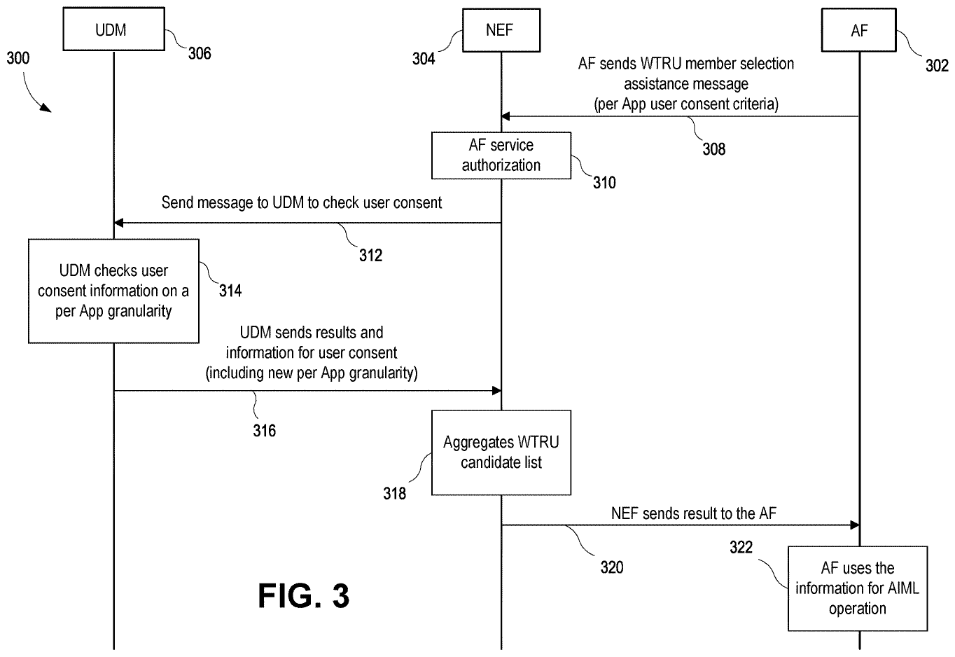

FIG. 3 illustrates an example procedure 300 for WTRU member selection assistance based on per-app user consent. An NEF 304 may receive (e.g., additional) filtering criteria and/or a list of target WTRUs from an AF 302. The additional filtering criteria may be based on user consent. The NEF 304 may receive WTRU subscription data from the UDM 306. The WTRU subscription data may comprise user consent value(s) for the AF 302 operation (e.g., some, all, none). In examples, the NEF 304 may request subscription data from the UDM 306 if it does not receive the user consent filtering criterion from the AF 302. The NEF 304 may receive the user consent information from the UDM 306. The NEF 304 may perform filtering based on the received user consent information and/or other filtering criteria. The NEF 304 may send a filtered list of WTRUs to the AF 304.

At 308, the application function (AF) 302 may send a WTRU member selection assistance request to the 5GS (e.g., by invoking an NEF API). The request from the AF 302 may comprise a list of wireless transmit/receive units (WTRUs) and/or one or more filtering criteria. In examples, the filtering criteria may comprise one or more of a user consent criterion, a WTRU(s) location, a minimum number of WTRUs, a maximum number of WTRUs, an area of interest, a QoS of a target WTRU, and/or a preferred access/RAT type. The request from the AF 302 may comprise filtering criteria associated with one or more (e.g., refined) user consent values and/or characteristic(s). For example, filtering criteria may indicate to select WTRUs where the user consent per-app is uniform, and a WTRU may provide different user consent for particular applications. In this example, the WTRU user consent value may be associated with a respective characteristic of differentiated user consent, not uniform, and may not fit within the filtering criteria. Thus, the WTRU may be ineligible for the requesting application function (e.g., Federated Learning application).

The filtering criteria provided by the AF 302 and the WTRU user consent values may comprise a user consent criterion that may be based on a variety of parameters. For example, the AF 302 may indicate that per-app user consent is provided over a certain duration in time, or a certain window of time. At 310, the NEF 304 may authorize the request sent by the AF 302.

At 312, the NEF 304 may send a message to the UDM 306. The message may be a request for WTRU subscription data, and may comprise the application ID, an application group ID, and/or an application category. In examples, the message may use the service operation Nudm_SDM_Get.

At 314, the UDM 306 may check the subscription data for a WTRU (e.g., a respective WTRU of the list of WTRUs included in the request from the AF 302). The UDM 306 may check the requested information on a per-app granularity. The UDM 306 may utilize the application ID, group ID, and/or application category (e.g., received from the NEF 304) for per-app user consent. The WTRU subscription data may comprise one or more user consent value(s) associated with a WTRU. The UDM 306 may check if the user consent value has an associated category. WTRU user consent value(s) may be associated with particular application(s) (e.g., categories of application, group of applications, all applications, etc.). There may be a respective characteristic associated with WTRU user consent value(s) indicating whether the user consent value is of a particular category (e.g., differentiated consent, uniform consent). For example, a user consent value may be labeled as a uniform consent or strict consent for a certain application category.

At 316, the UDM 306 may provide the subscription data of a WTRU (e.g., a respective WTRU of the list of WTRUs included in the request from the AF 302) to the NEF 304. For example, the UDM 306 may provide the subscription data for each WTRU of the list of WTRUs. The subscription data may comprise respective user consent value(s) (e.g., for a specified application, a group of applications, or category of applications) for the WTRU, and may comprise the characteristic of the user consent (e.g., uniform, or strict). For example, the subscription data for a WTRU may include a first user consent value associated with a first application or group of applications and a second user consent value associated with a second application or group of applications.

At 316, The NEF 304 may perform filtering and/or may determine if the WTRU is an eligible candidate WTRU. The NEF 304 may have received the relevant (e.g., all) WTRU information related to the filtering criteria provided by the AF 302. The NEF 304 may determine if the WTRU is an eligible candidate based on the filtering request (e.g., from the AF 302), filtering criteria, and/or per-app user consent value(s). The NEF 304 may determine if a WTRU matches the filtering criteria (e.g., considering the per-App user consent and the user consent criteria from AF 302). For example, for an application with Application ID 1, user consent associated with a first WTRU (e.g., WTRU-1) may be not given or may be given for a window of time incompatible with the window of time requested by the AF 302. In this case, WTRU-1 may not be selected by the NEF 304 as an eligible candidate WTRU. At 320, the NEF 304 may send the information comprising the determined candidate WTRUs to the AF 302.

WTRU member selection assistance may be based on user consent and security status. Procedures described herein (e.g., the procedure 200 for selection based on user plane security and the procedure 300 for selection based on per-app user consent 300) may be utilized together. In examples, the filtering criteria (e.g., provided by the AF 202, 302) may comprise security status criteria and/or user consent criterion. Based on procedures and embodiments described herein, the NEF 204, 304 may perform filtering and may determine if a WTRU is a candidate WTRU based on security status criteria, user consent criterion, and/or additional filtering criteria.

The processes and instrumentalities described herein may apply in any combination, may apply to other wireless technologies, and for other services. A WTRU may refer to an identity of the physical device, or to the user's identity such as subscription related identities, e.g., MSISDN, SIP URI, etc. WTRU may refer to application-based identities (e.g., usernames that may be used per application).

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1-20. (canceled)

21. A network node comprising a processor configured to:
receive, from an application function (AF), a list of wireless transmit/receive units (WTRUs) and one or more filtering criteria, wherein the filtering criteria comprise a user consent criterion;
receive, from a unified data management (UDM), respective subscription data for each WTRU of the list of WTRUs, wherein the respective subscription data comprises a respective user consent value associated with the WTRU;
filter the list of WTRUs received from the AF based on the filtering criteria and the received user consent values; and
send, to the AF, the filtered list of WTRUs.

22. The network node of claim 21, wherein the processor being configured to filter the list of WTRUs received from the AF based on the filtering criteria and the received user consent values comprises the processor being configured to determine, for each WTRU of the list of WTRUs, whether the WTRU is eligible to be a candidate WTRU.

23. The network node of claim 21, wherein the processor is further configured to receive, from the AF, a time duration associated with the user consent criterion.

24. The network node of claim 21, wherein the processor is further configured to receive, from the UDM, a respective characteristic associated with the user consent values, wherein the respective characteristic indicates that the user consent value is associated with uniform consent or strict consent.

25. The network node of claim 21, wherein the network node is a network exposure function (NEF).

26. The network node of claim 21, wherein the filtering criteria further comprise one or more of a minimum number of WTRUs, a maximum number of WTRUs, a WTRU location, an area of interest, a QoS of a target WTRU, or a preferred access or radio access technology type.

27. The network node of claim 21, wherein the respective user consent value associated with the WTRU is a first user consent value associated with a first application or group of applications, and wherein the respective subscription data for each WTRU of the list of WTRUs further comprises a second user consent value associated with a second application or group of applications.

28. The network node of claim 21, wherein the respective user consent value is associated with data collection for one or more applications running on the respective WTRU.

29. The network node of claim 21, wherein the processor is further configured to send, to the UDM, a request for the respective subscription data for each WTRU of the list of WTRUs, wherein the request comprises one or more of an application identifier (ID), an application group ID, or an application category.

30. The network node of claim 21, wherein the list of WTRUs received from the AF is further filtered based on a security status criterion.

31. A method performed by a network node, the method comprising:
receiving, from an application function (AF), a list of wireless transmit/receive units (WTRUs) and one or more filtering criteria, wherein the filtering criteria comprise a user consent criterion;
receiving, from a unified data management (UDM), respective subscription data for each WTRU of the list of WTRUs, wherein the respective subscription data comprises a respective user consent value associated with the WTRU;
filtering the list of WTRUs received from the AF based on the filtering criteria and the received user consent values; and
sending, to the AF, the filtered list of WTRUs.

32. The method of claim 31, wherein the filtering the list of WTRUs received from the AF based on the filtering criteria and the received user consent values comprises determining, for each WTRU of the list of WTRUs, whether the WTRU is eligible to be a candidate WTRU.

33. The method of claim 31, further comprising:
receiving, from the AF, a time duration associated with the user consent criterion.

34. The method of claim 31, further comprising:
receiving, from the UDM, a respective characteristic associated with the user consent values, wherein the respective characteristic indicates that the user consent value is associated with uniform consent or strict consent.

35. The method of claim 31, wherein the network node is a network exposure function (NEF).

36. The method of claim 31, wherein the filtering criteria further comprise one or more of a minimum number of WTRUs, a maximum number of WTRUs, a WTRU location, an area of interest, a QoS of a target WTRU, or a preferred access or radio access technology type.

37. The method of claim 31, wherein the respective user consent value associated with the WTRU is a first user consent value associated with a first application or group of applications, and wherein the respective subscription data for each WTRU of the list of WTRUs further comprises a second user consent value associated with a second application or group of applications.

38. The method of claim 31, wherein the respective user consent value is associated with data collection for one or more applications running on the respective WTRU.

39. The method of claim 31, further comprising:
sending, to the UDM, a request for the respective subscription data for each WTRU of the list of WTRUs, wherein the request comprises one or more of an application identifier (ID), an application group ID, and an application category.

40. The method of claim 31, wherein the list of WTRUs received from the AF is further filtered based on a security status criterion.
